(19) United States
(12) Patent Application Publication
(10) Pub. No.: US 2025/0360033 A1
(43) Pub. Date: Nov. 27, 2025

(54) MOBILITY DEVICE TYPE DETECTION FOR A MOBILITY DEVICE SECUREMENT SYSTEM

(71) Applicant: Valeda Company, LLC, Oakland Park, FL (US)

(72) Inventors: Jose Fernandez, Sunrise, FL (US); Jorge Figueredo Cuesta, Hollywood, FL (US); William Ott, Fort Lauderdale, FL (US)

(73) Assignee: Valeda Company, LLC, Oakland Park, FL (US)

(21) Appl. No.: 19/216,836

(22) Filed: May 23, 2025

Related U.S. Application Data
(60) Provisional application No. 63/650,978, filed on May 23, 2024.

(51) Int. Cl. A61G 3/08; B60P 7/08

(52) U.S. Cl. CPC A61G 3/0808; B60P 7/08

(57) ABSTRACT

A method for increasing the securement of a wheeled mobility device in a securement system is disclosed. The method may include a programed monitoring system that may determine the nature of the wheeled mobility device being secured. Based on the monitoring, the system may execute logic to further apply securement force the wheeled mobility device if necessary, or may send a signal to deploy one or more retractable pins to engage in cavities of the wheeled mobility device.

### CROSS REFERENCE TO OTHER APPLICATIONS

This application claims priority to U.S. Provisional Patent Application No. 63/650,978, filed May 23, 2024, the contents of which is incorporated herein. This application also incorporates by reference International Patent Application No. PCT/US25/30496, filed May 22, 2025. Further, the contents of U.S. Pat. Nos. 11,872,167, 11,819,462, 11,660,238, 10,702,429, 10,350,120, 10,166,907, 10,071,004, and 7,040,847, and U.S. Patent Publication No. US2022-0234533 are all incorporated herein by reference.

### FIELD OF THE DISCLOSURE

The present disclosure relates generally to a passenger vehicle that has been modified to allow access by, and securement of a passenger, and more particularly to securing a personal mobility device (PMD), and more particularly to a system for detecting the type of PMD and optionally applying customized securement parameters for the detected type of PMD.

### BACKGROUND

OEM vehicle manufacturers generally do not manufacture or sell accessible vehicles for physically limited passengers. Aftermarket outfitters are then left to modify the OEM vehicles to make them accessible. The most important part of outfitting an accessible vehicle is keeping the passenger safe during operation of the vehicle. Many passengers will use a personal mobility device (PMD) to move around outside of the vehicle. Some passengers are able to transfer from their PMD to the car seat, but for those who cannot, the accessible vehicle outfitter needs to secure the PMD with the passenger seated in the PMD inside the vehicle.

Systems have been developed and employed to secure PMDs and PMD-bound occupants (referred to herein as mobility passengers). These systems are typically comprised of occupant restraints that include at least one shoulder belt along with one or more lap belts. They may also include some form of PMD securement that could comprise one or more tie-downs (e.g., belts), bumpers, barriers, docks, latches and/or automated grippers. These systems have proven successful in meeting occupant stability needs and basic crash test requirements. However, most securement systems are configured to fit all wheelchair types with a single securement condition. As previously stated, these systems have been safe for basic crash test requirements, but for extreme conditions it may provide further safety if the securement conditions were tailored to the type of wheelchair. For example, if a wheelchair is more structurally solid, additional forces may be applied by the securement system.

Rear-facing compression-based systems have been developed to increase mobility passenger independence. These systems primarily comprise a backrest and two bumpers, in the form of arms located at opposite sides of the backrest. To use the system, the mobility passenger centers their PMD against the backrest as best they can and engages an automatic locking sequence by pressing an ADA-friendly button. The compression arms deploy and engage with the PMD on opposite side surfaces by compression to safely secure the mobility passenger in place. The arms adjust their grip as needed (i.e., apply additional squeezing force), in response to sensors that detect the level of force or compression applied to the PMD. Once the vehicle stops at the mobility passenger's destination, the button is pressed again to release the compression arms so that they can disembark.

Another common method for securing wheelchairs is with one or more tie-downs, often a plurality in a wheelchair tie-down and occupant restraint system, WTORS. In the most common WTORS configuration, four tie-downs are utilized, one in tension at each corner of the wheelchair. The tie-downs extend from each corner to an anchor point on the floor at an angle of roughly 30-45°. In that regard, all of the tie-downs exert a downward force on wheelchair against the floor. Additionally, the front tie-downs exert a forward force on the wheelchair and the rear tie-downs exert a rearward force on the wheelchair. In these systems, the tie-downs are commonly mechanically self-retracting. Additionally, tie-downs may use an electric motor to retract the strap in conjunction with sensors to control the level of force applied to the wheelchair. Other methods for powering a retractor may be considered as well.

To assist ingress and egress of the passenger while seated in the PMD, a vehicle may be provided with a powered winch for pulling the PMD up a vehicle access ramp and into a securement area. The powered winch may additionally serve as a tie-down, or a separate system may be employed to secure the PMD after it is properly positioned in the securement area.

The inventions disclosed in this application introduce improvements upon powered PMD securement and winch systems.

### SUMMARY OF THE EMBODIMENTS

The inventions described herein comprise improvements to a wheelchair securement system, such as securement systems that utilize one or more moveable bumpers (for example, one or more moveable bumpers incorporated into a 3-point or 2-point or 1-point tie-down system, see U.S. Pat. Nos. 10,350,120 and 10,071,004 and U.S. Patent Publication No. US2017-0128290A1, which are all incorporated herein by reference), and securement systems that use one or more powered tie-down retractors or winches, such as U.S. Pat. No. 11,660,238, or a safety system controller, such as U.S. Patent. Pub. No. 2022/0234533, which are all incorporated herein by reference.

In one embodiment, a compression-based mobility passenger securement system may include monitoring of the compression arm assembly (ies) to determine the type of PMD the mobility passenger is using. Manual wheelchairs typically fold up along the axis of the wheels. For that reason, these types of PMDs cannot be squeezed nearly as firm as an electrical power chair. Over-compression of a manual chair may cause it to fold or deform, creating discomfort for the mobility passenger. For PMDs that can withstand more compression force, such as a power chair, it is encouraged to use more compression force because that means better safety of securement for the PMD and the mobility passenger.

In another embodiment, a powered winch and/or wheelchair tie-down retractor may include monitoring of the retractor to determine the type of PMD the mobility passenger is using, similar to the previously disclosed embodiment for a compression-based wheelchair securement system. A powered retractor may be individually monitored, or a single computing device may monitor a system that includes a plurality of retractors. A sensor may be configured to the powered retractor to measure the force or tension in the strap connecting it to the PMD. Manual wheelchairs typically use a lightweight, hollow tubular frame to ease the effort required by the individual to move themselves in the wheelchair. Too much force for a tie-down may result in damage to the wheelchair that could cause mobility problems. Contrarily, powered wheelchairs are heavy and substantially solid bodies, and many times include an anchor point for a tie-down to attach to. This anchor may withstand more force than the frame of a manual wheelchair. Since it is substantially heavier, the force required to restrain it during an event may be higher as well. Tie-downs are typically constructed of a webbed strap, so the heavy powered wheelchairs may cause stretching in the straps that may cause further movement during an event. For the many reasons listed, it would be safer to add further force to the tie-down if a powered wheelchair is being secured.

In one example of each of the preceding embodiments, a computing system may be utilized that may include a processor may monitor the current peaks of an electric motor powering the securement system during the securement phase. Other electrical relationships or parameters, such as voltage, resistance, and power, may also be monitored for this determination, as well as other known electrically related measurements. For the avoidance of doubt, the invention will primarily be described in the context of a system that utilizes current measurements, but the principles and methods disclosed are equally applicable if another electrical parameter measurement is used. Because the current can experience small spikes herein referenced as noise, an algorithm may be used to filter out the noise in order to achieve a readable and meaningful value. In one example of this embodiment, the algorithm used may be an average of the readings. A first routine may be utilized to detect if the average current reaches a first programmed threshold, which is indicative of when the securement system begins applying force to the PMD. A second routine may be added to detect if the current average reaches a second programmed threshold, which is indicative of when the securement system is applying a desired level of force on the PMD. When the current average reaches the first threshold, the processor may activate a timer. The timer may be a counter or any other well-known method for measuring duration. When the current average reaches the second threshold, the processor may halt the timer. The processor may then receive the value reached by the timer and use it to determine the nature of the PMD being secured. In one implementation, the processor may store a table of values that correspond to a plurality of PMD types. When referencing these stored values against the value reached by the time keeping device, the processor may then make the determination of the type of PMD being secured, and make decisions based on this determination.

In another example of the embodiments, the processor may receive input from a sensor that directly detects the force being applied to the PMD, for example by a pressure sensor, a stress/strain gauge, or similar device disposed on the compression arm assemblies or on a tie-down or winch strap.

In another example of the embodiments, the processor may receive input from one or more sensors associated with a PMD winch that outputs a signal indicative the weight of the PMD as it is being pulled up a ramp. In one example system where the ramp angle may be known or sensed and the position of the PMD on the ramp may be known or sensed, the weight of the wheelchair may be detected based on the winch motor current or stress/strain in the strap.

In another example of the embodiments, the motorized systems may be hydraulically or pneumatically powered. Similar to monitoring the electrical draw, the processor may monitor the system pressure or flow, or related parameters, to evaluate the nature of the PMD being secured.

In another embodiment, a bumper in a compression-based securement system may include a plurality of retractable pins to grip the PMD in cavities. The compression arms may already include textured features to grip non-flat surfaces. If the compression arms were substantially planar, the only force securing the mobility passenger would be the friction between the compression arms and the PMD. The texture of the pliable compression arms may increase the shear grip by not relying on friction alone but small-scale engagement of the surface texture. Retractable pins take this idea a step further. The pins may be deployed to engage in cavities of the PMD such as the wheel spokes in a manual wheelchair. If the pins were fixed in a deployed position, the surface area of the contact area between the pins and a PMD without cavities would be greatly reduced, also reducing the friction, therefore retractable pins may accomplish the best compromise. The pins may be linearly deployed with an electronic, pneumatic, or hydraulic linear actuator, or any other known method of linearly deploying and retracting a component. The pins on the same compression arm may be operatively connected in the same pneumatic or hydraulic system such that only some of the pins may have enough supply pressure to deploy into a gap while others that hit a substantially solid and immovable part of the PMD may not deploy.

In a second example of this embodiment, the determination of type of PMD may be used to control if the retractable pins are deployed or retracted. For electric power wheelchairs, the body of the wheelchair may be smooth such that pins cannot substantially engage in any cavities. As previously disclosed, deploying the pins when they are not engaging in cavities may reduce the security of the mobility passenger, as it reduces the contact area between the securement system and the PMD. In contrast, deploying the retractable pins to engage with a manual chair having such cavities may secure the mobility passenger further since the manual chairs cannot be secured with as much force.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a prior art wheeled mobility device securement system in a stow position with the aisle side bumper up and retracted and the wall side bumper extended.

FIG. 2 is a second perspective view of the prior art wheeled mobility device securement system, shown in a deploy position with the aisle side bumper up and both bumpers extended.

FIG. 3 is a third perspective view of the prior art wheeled mobility device securement system, shown in an engage position with the aisle side bumper down and both bumpers extended.

FIG. 4 is a fourth perspective view of the prior art wheeled mobility device securement system, shown in a secure position with the aisle side bumper down and both bumpers retracted.

FIG. 5 is a perspective view of an improved wheeled mobility device securement system, shown in a different configuration than the systems in FIGS. 1-4 and also shown in an engage position with the aisle side bumper down and both bumpers extended.

FIG. 6 is a logic flow chart for the process of determining the nature of the wheeled mobility device being secured by a system.

FIG. 7 is an example graph of a current draw profile for an electric motor during the securement of a wheeled mobility device.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

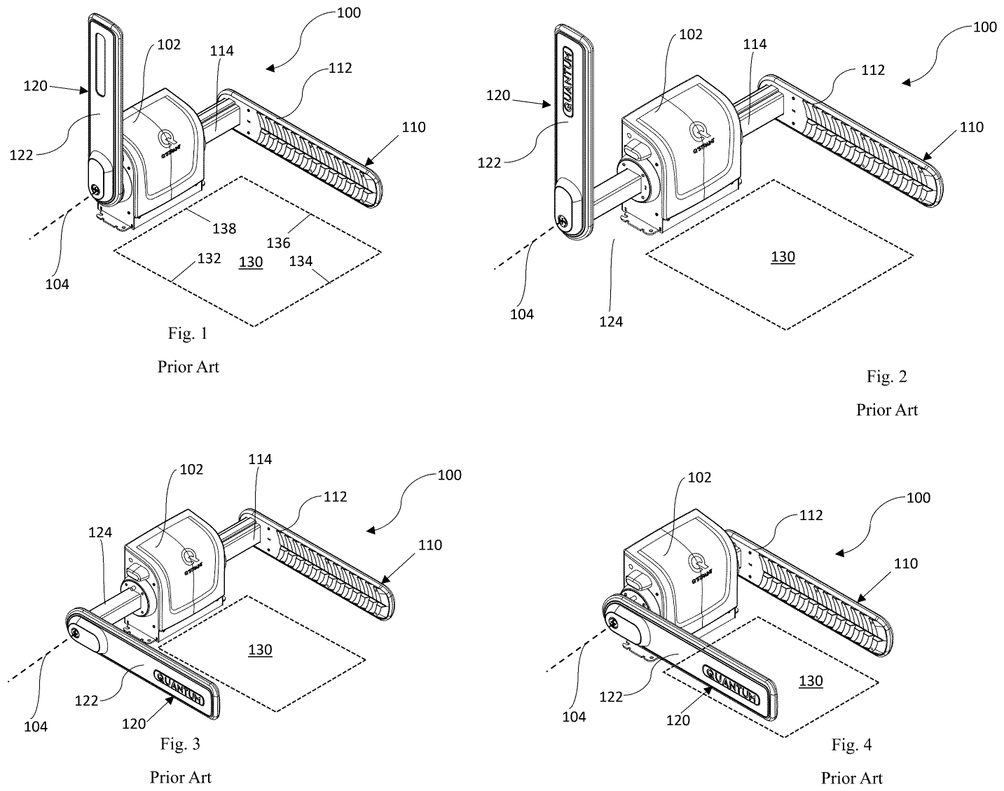

FIGS. 1-4 show a prior art wheeled mobility device securement system 100 for securing a wheeled mobility device in a vehicle. The system 100, or components thereof, may be used in a vehicle as shown (bolted to a surface, such as the floor), or may be incorporated or integrated into other components or modules of a vehicle, such as walls or seat bases. Additionally, the system 100 could be combined with various other securement components, such as a backrest, occupant restraints, wheeled mobility device tie-downs, additional bumpers, and/or other supplemental securement systems (airbags, etc.).

The system 100 may, as shown, comprise a body assembly 102 holding a first bumper 110 and a second bumper 120. The bumpers 110, 120 may, as shown, define compression arms 112, 122 that extend from arm tubes 114, 124 (or telescoping members). The arm tubes 114, 124 may be configured (as discussed in more detail below) to extend from and retract into the body assembly 102 (i.e., move in both directions along a lateral axis 104). In addition, one or more of the arm tubes, in this case arm tube 124, may be configured to rotate about the lateral axis 104. In a typical embodiment, both bumpers 110, 120 will be moveable in both directions along a lateral axis 104, but only one will be a rotating bumper (in this case, bumper 120) and one will be a non-rotating bumper (in this case, bumper 110). However, in some embodiments, both bumpers may be rotating or both may be non-rotating. Although the bumpers 110, 120 are configured to move linearly along lateral axis 104, other embodiments need not move linearly. See, for example, U.S. Pat. No. 11,872,167.

The embodiment shown in FIGS. 1-4 may be configured to secure a wheeled mobility device in either: (1) a rear-facing configuration with the first bumper 110 disposed adjacent to a right-side vehicle wall and the second bumper 120 located adjacent an aisle of the vehicle; (2) a forward-facing configuration with the first bumper 110 located adjacent a left-side vehicle wall and the second bumper 120 located adjacent a vehicle aisle; or (3) a side-facing configuration with the body assembly 102 adjacent a vehicle wall and the first bumper 110 adjacent a modesty barrier. Other configurations are contemplated and possible by modifying the structure and function of first and second bumpers 110, 120. For example, to facilitate a rear-facing configuration with the system located between a left-side vehicle wall and vehicle aisle, a mirror image of the system 100 could be used (e.g., wherein a non-rotating bumper could be used in place of bumper 120 and a rotating bumper could be used in place of bumper 110). In other embodiments, the vehicle may not have an aisle or a modesty barrier, in which case each bumper could be adjacent a vehicle wall or other vehicle structure.

In FIG. 1, the system 100 is shown in a stow position with the first bumper 110 down and extended (away from the body assembly 102, and adjacent a vehicle wall) and the second bumper 120 up and retracted (adjacent to the body assembly 102 and away from the vehicle aisle). The second bumper 120, being positioned in both the up and retracted position, reduces a tripping hazard that may otherwise be present due to the system 100 extending into the vehicle aisle. In the stow position, the system 100 is ready to receive a wheeled mobility device in the wheelchair securement area 130. In particular, a wheelchair passenger can back their wheeled mobility device into the wheelchair securement area 130 and toward the body assembly 102 (whereby the seatback of the wheeled mobility device will be adjacent or touching a backrest extending upward from the body assembly 102, if present). Access into the wheelchair securement area 130 from the aisle of the vehicle is made easy by keeping the second bumper 120 in the up position.

In FIG. 2, the system 100 is shown in a deploy position, whereby the second bumper 120 has moved outward from the body assembly 102. In FIG. 3, the system is shown in an engage position, whereby the second bumper 120 is rotated downward where it may be generally parallel with the first bumper 110, after which the first and second bumper 110, 120 each begin to move toward each other until both of the bumpers 110, 120 engage with the wheeled mobility device. Because each bumper 110, 120 is capable of continuing to move even after the other bumper 110, 120 has contacted the side of the wheeled mobility device, the system 100 is capable of securing a wheeled mobility device that is located off center in the wheelchair securement area 130.

In FIG. 4, the system 100 is shown in a wheelchair secure position, whereby the first and second bumper 110, 120 are intended to be engaged with opposite sides of the wheeled mobility device and are applying a compressive, securing force on the wheeled mobility device.

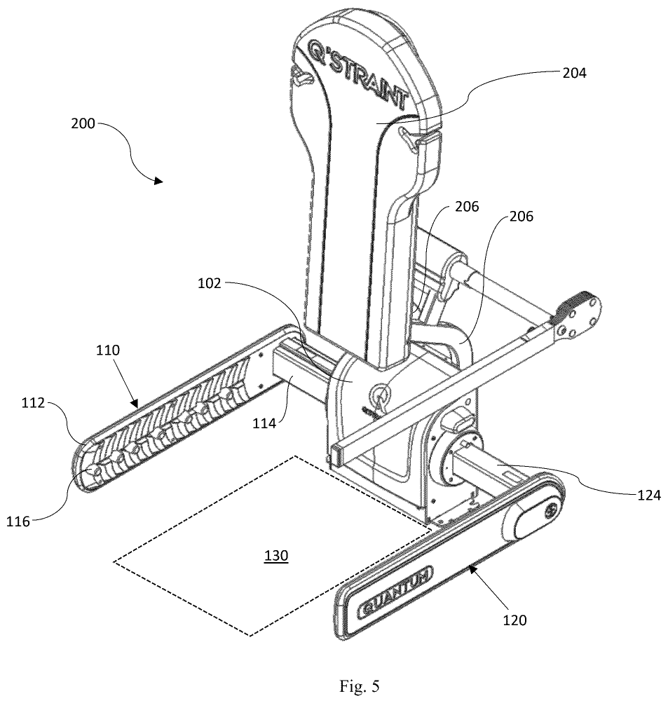

FIG. 5 illustrates the securement system 200 in an opposite configuration as system 100 in FIGS. 1-4 with the aisle and the bumpers 110, 120 being on opposites sides of the body assembly 102. The system 200 includes a backrest 204 supported by one or more supports 206 connected to the base 102, the floor, or other structure. FIG. 5 shows a plurality of fixed pins 116 on the first bumper 110. The plurality of pins 116 may provide extra security for PMDs that have cavities that the fixed pins 116 may fit in (e.g., between spokes or hand grips on the wheels of a manual/foldable wheelchair). However, some PMDs such as powered wheelchairs are substantially solid with minimal cavities, therefore these fixed pins 116 may reduce the contact area between the first bumper 110 and the PMD. In that regard, in other embodiments (not shown), the pins 116 or differently shaped protrusions, may be configured to move between a deployed position, as shown and a retracted position, so that the pin 116 (or other shaped protrusion/structure) is behind or approximately flush with the contact surface of the bumper 110, 120. In some embodiments, the pins 116 may be independently moveable whereby some pins 116 may stay in the stowed position and/or only partially deploy (for example if the pin 116 contacts a portion of the PMD prior to full deployment) while the remaining pins 116 will completely deploy.

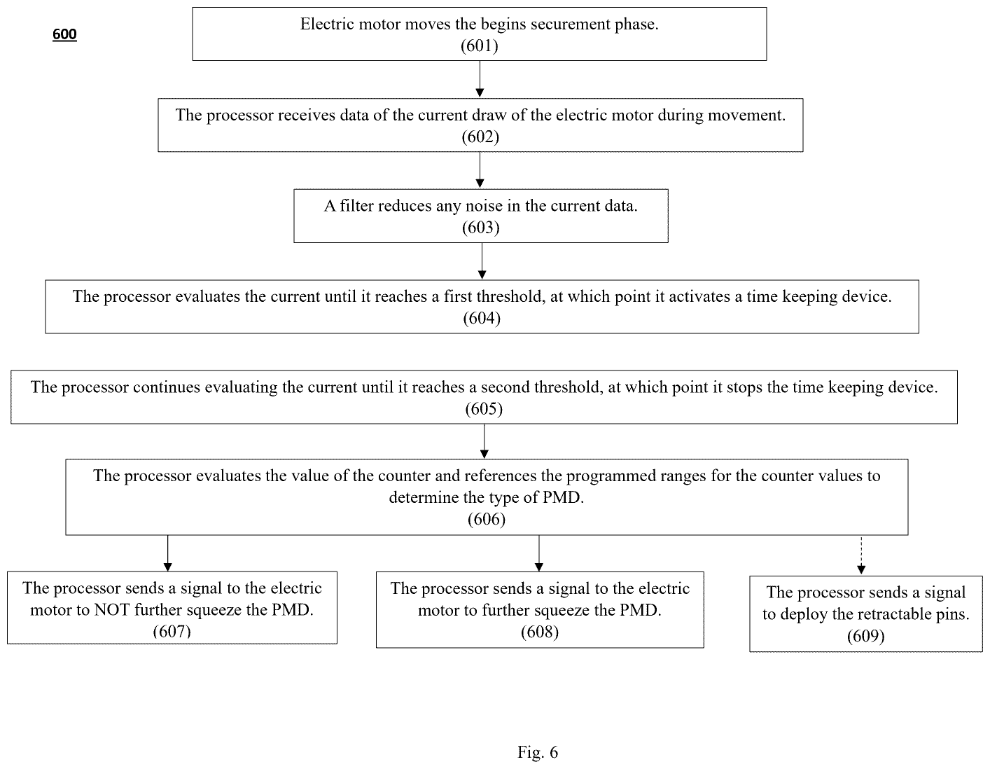

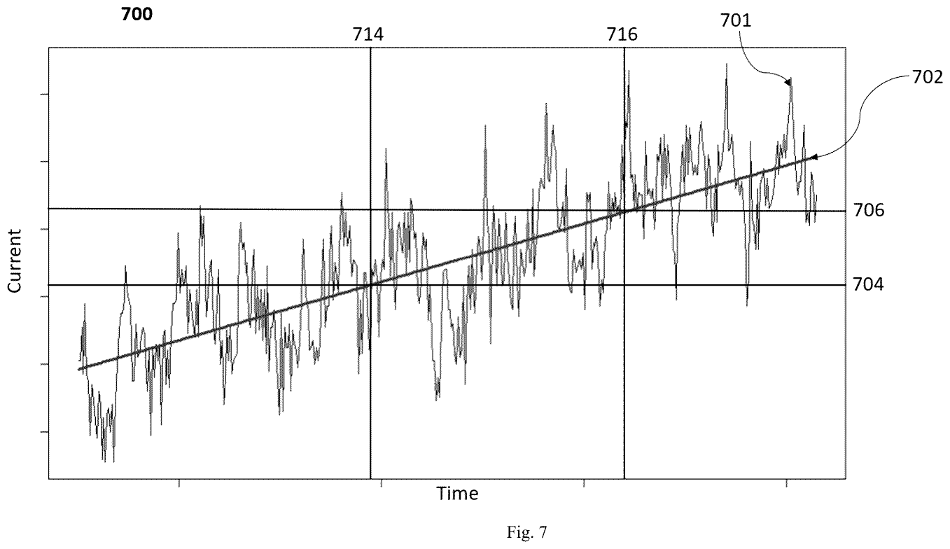

FIG. 6 illustrates a flow chart of logic 600 that a computing system including a processor may execute to determine the nature of the PMD being secured in a securement system. A hypothetical example of a current draw by the electric motor during the securement phase is illustrated in FIG. 7. In the first step 601 of logic 600, the electric motor begins to transmit power to the securement system to initiate securement. While the electric motor is activated, in step 602 the processor may be evaluating the current draw of the electric motor, as shown in series 701. Outside factors may interfere with the securement process and cause noise in the current reading. For example, in a compression-based system with two bumpers, the bumpers are linearly adjustable to accommodate variable wheelchair positioning, so the current may spike briefly if one bumper contacts the wheelchair before the other. Similarly, in a tie-down, the slack in the strap may get caught on something while retracting and cause a small spike, or in a system with multiple tie-downs, the slack in each retractor may get drawn out at different times. To more accurately monitor the current, a filter for the rate of increase of the average current may be utilized. Other formulaic relationships such as voltage, resistance, power, or any other electrical measurement may also be used to monitor the draw of the electric motor.

To avoid the current noise due to nonsignificant factors, a current average filter is applied to average out the current in step 603. This results in an average current profile 702. The algorithm may take thousands of measurements per second and take a running average of a selected number of the last measurements to get the average current profile 702. In step 604, the processor evaluates the current and when it reaches a programmed first threshold 704, it activates a timer or other time keeping device at 714. A fixed delay may be programmed to suspend the initiation of the time keeping device as a verification method. Such a delay would prevent extreme noise measurements from reaching the first threshold and skewing the results of the time keeping device. The time keeping device may be a timer, a counter, or other known time keeping devices. During this phase, a controller may be used to maintain a desired constant motor speed. The desired motor speed may be slower than the full speed to increase measurement accuracy. A timer is contemplated to be used, but there are limitations to the accuracy of finite time periods. A counter may provide smaller increments and more resolution.

When the current reaches a programmed second threshold 706, the processor halts the time keeping device in step 605 at 716. In step 606 the processor evaluates the value reached by the time keeping device between 714 and 716 and compares the value to a programmed range, a plurality of programmed ranges, or a reference table of ranges. The programmed ranges may be determined during testing and programmed into memory for the processor, the ranges corresponding to a type of PMD being secured. By referencing how long it takes to the current to get between two parameters 704, 706, the data is simply measuring the slope, or derivative, of the average current profile 702. In that regard, rather than using the time it takes for the current to go between the two current thresholds 704, 706, and comparing that time to stored time ranges, the processor could instead determine the average slope of the current series 701 or current profile 702, and then compare that slope to stored slope ranges that are cross referenced with the type of PMD being secured. Once the processor concludes the type of PMD, the processor may send a signal (or omit a signal) to the electric motor to: not squeeze the PMD further as in step 607 (or in some embodiments reduces the squeezing force exerted on the PMD) or squeeze the PMD to a stronger force as in step 608. The selected force setting in step 608 may be different depending upon the type of PMD, e.g., higher for a power chair as compared to the manual chair. An optional further step, if the securement system is a compression-based securement system and a bumper is equipped with retractable pins, the processor may send a signal to deploy the retractable pins based on the processor's evaluation as in step 609, for example if the PMD is a manual wheelchair.

A similar process as that shown in FIG. 6 may be followed for PMD securement systems utilizing tie-downs, except that in Steps 607 the processor will either leaves the tension in the tie-downs the same or reduces the tension and in Step 608 increases the tension in the tie-downs.

The systems described herein may include a computing device that can perform some or all of the processes and methods described above. The computing device may include a processor, storage, an input/output (I/O) interface, and a communications bus. The bus connects to and enables communication between the processor and the components of the computing device in accordance with known techniques. Note that in some computing devices there may be multiple processors incorporated therein, and in some systems there may be multiple computing devices. The processor 120 communicates with storage via the bus. Storage may include memory, such as Random Access Memory (RAM), Read Only Memory (ROM), flash memory, etc., which is directly accessible. Storage may also include a secondary storage device, such as a hard disk or disks (which may be internal or external), which is accessible with additional interface hardware and software as is known and customary in the art. Note that a computing device may have multiple memories (e.g., RAM and ROM), multiple secondary storage devices, and multiple removable storage devices (e.g., USB drive and optical drive). The computing device may also communicate with other computing devices, computers, workstations, etc. or networks thereof through a communications adapter, wired or wireless. Note that the computing device may use multiple communication adapters for making the necessary communication connections. All these configurations, as well as the appropriate communications hardware and software, are known in the art. The computing device may be located onboard a wheeled mobility device securement system, or may be located remotely in the vehicle or elsewhere.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method implemented by a computing device for securing a personal mobility device in a vehicle, the method comprising:
receiving at least one data point indicative of a force variable applied to the personal mobility device by a securement system over a period of time;
setting at least one securement parameter of the securement system based on the at least one data point.

2. The method of claim 1, further comprising the step of determining a type of the personal mobility device based on the at least one data point.

3. The method of claim 1, wherein the at least one data point is a set of data points indicative of the force variable applied to the personal mobility device by the securement system over the period of time.

4. The method of claim 3, wherein the securement system is one of a hydraulically powered securement system and a pneumatically powered securement system, and the at least one data point is a measure of at least one of a flow rate and a pressure of the one of the hydraulic securement system and the pneumatically powered system.

5. The method of claim 3, wherein the securement system is an electrically powered system, and the at least one data point is a measure of at least one of a current, a voltage, a resistance, and a power.

6. The method of claim 3, wherein the period of time corresponds to when the set of data points indicative of the force variable applied to the personal mobility device is between a first threshold and a second threshold, wherein the first threshold corresponds to a lower force variable than the second threshold.

7. The method of claim 6, wherein the method further comprises measuring a duration of time between when the first threshold and second threshold are reached.

8. The method of claim 7, further comprising the step of filtering the set of data points to reduce measurement noise.

9. The method of claim 7, further comprising the steps of initiating a time keeping device wherein when the set of data reaches the first threshold, and halting the time keeping device when the set of data reaches the second threshold.

10. The method of claim 9, wherein the step of setting the at least one securement parameter of the securement system based on the at least one data point includes referencing an output from the time keeping device against a data table, the output being indicative of the duration of time between when the first threshold and second threshold are reached.

11. The method of claim 10, wherein the step of setting at least one securement parameter of the securement system based on the at least one data point includes increasing the force variable based on the data table.

12. The method of claim 11, wherein the securement system is a compression-based securement system with at least one bumper to configured to exert the force variable on the personal mobility device.

13. A securement system for securing a personal mobility device in a vehicle, the securement system comprising:
a computing device configured to receive at least one data point indicative of a force applied by a securement system over a time frame and set at least one securement parameter of the securement system based on the at least one data point.

14. The securement system of claim 13, the computing device further being configured to determine a type of the personal mobility device being secured by the securement system based on the at least one data point.

15. The securement system of claim 13, wherein the at least one data point is a set of data points indicative of the force applied to the personal mobility device by the securement system over the time frame.

16. The securement system of claim 15, wherein the securement system is one of a hydraulically powered securement system and a pneumatically powered securement system, and the at least one data point is a measure of at least one of a flow rate and a pressure of the one of the hydraulic securement system and the pneumatically powered system.

17. The securement system of claim 15, wherein the securement system is an electrically powered system, and the at least one data point is a measure of at least one of a current, a voltage, a resistance, and a power.

18. The securement system of claim 15, wherein the computing device is configured to initiate a time keeping device when the set of data reaches a first threshold, and further wherein the computing device is configured to halt the time keeping device when the set of data reaches a second threshold;
wherein the time frame corresponds to when the set of data points indicative of the force applied to the personal mobility device is between a first threshold and a second threshold; and,
wherein the first threshold corresponds to a lower force variable than the second threshold.

19. The securement system of claim 18, wherein the computing device is configured to reference an output from the time keeping device against a data table, the output being indicative of the time frame, and send a signal to the securement system to increase the force variable.

20. The securement system of claim 19, wherein the securement system is a compression-based securement system with at least one bumper configured to exert the force variable on the personal mobility device.
